(19) United States
(12) Patent Application Publication
(10) Pub. No.: US 2013/0053092 A1
(43) Pub. Date: Feb. 28, 2013

(54) METHOD AND APPARATUS FOR PRODUCING NEIGHBOR MEASUREMENT REPORTS

(71) Applicants: Pasi Petteri Laitinen, Oulunsalo (FI); Antti-Eemeli Suronen, Oulu (FI); Antti Olavi Kangas, Oulunsalo (FI)

(72) Inventors: Pasi Petteri Laitinen, Oulunsalo (FI); Antti-Eemeli Suronen, Oulu (FI); Antti Olavi Kangas, Oulunsalo (FI)

(73) Assignee: RENESAS MOBILE CORPORATION, Tokyo (JP)

(21) Appl. No.: 13/215,877

(22) Filed: Aug. 23, 2011

(51) Int. Cl. H04W 36/00; H04B 7/26

(52) U.S. Cl. 455/525

(57) ABSTRACT

Methods and apparatus are provided from the context of a mobile terminal and a target base station for creating neighbor measurement reports in accordance with a measure of mobility that takes into account whether a handover is mobility-triggered without consideration of non-mobility-triggered handovers. In this regard, a method is provided that includes receiving information indicating whether a handover is mobility triggered. The method may also determine, with a processor, a measure of mobility at least partially based upon the handovers that are mobility triggered without consideration of non-mobility triggered handovers. The method may also cause neighbor measurement reports to be provided in accordance with the measure of mobility.

### TECHNOLOGICAL FIELD

Embodiments of the present invention relate generally to communications technology and, more particularly, to methods and apparatus for producing neighbor measurement reports that are dependent upon mobility state.

### BACKGROUND

In operation, a mobile terminal may be supported and serviced by a base station, such as an evolved Node B (eNB) in, for example, a third generation partnership project (3GPP) evolved universal mobile telecommunication system (UMTS) terrestrial radio access network (EUTRAN) system, in order to communicate via a network with other mobile terminals, various network entities or the like. For various reasons discussed below, the mobile terminal may be handed over from one base station, generally referenced as a source base station, to another base station, generally referenced as a target base station. Following the handover, the mobile terminal may then communicate with the other base station in order to communicate with other mobile terminals or to otherwise access the network.

The mobile terminal may be handed over from the source base station to the target base station for a variety of reasons. For example, the mobile terminal may be in transit such that while the source base station may initially be able to best service the mobile terminal, such as in terms of signal strength, signal quality or the like, the target base station may be able to best service the mobile terminal at a later point in time once the mobile terminal has relocated, such as by moving further from the source base station and closer to the target base station. The mobile terminal may also be handed over from the source base station to the target base station for other reasons that are unrelated to the mobility of the mobile terminal. These other non-mobility triggered handovers may include handovers that are intended to facilitate load balancing between the base stations or to provide a better quality of service to the mobile terminal even though the mobile terminal has not moved, at least not appreciably.

While a mobile terminal is supported by a respective base station, the mobile terminal may make various measurements of the neighboring base stations. For example, the measurements of the neighboring base stations may include measurements of signal strength, signal quality or the like for signals received from the neighboring base stations. The mobile terminal may, in turn, provide neighbor measurement reports to the base station that is presently supporting the mobile terminal. Based upon the neighbor measurement report, the network may make determinations regarding whether the mobile terminal should be handed over to another base station, such as another base station that could provide better service, such as in terms of signal strength, signal quality and the like.

In order to avoid excessive handovers which may create inefficiency, parameters, such as a time to trigger, have been established that define a minimum length of time that the measurements of the neighboring base stations must satisfy a predefined criteria in order to trigger the mobile terminal to issue a neighbor measurement report to the base station. By requiring the measurements of the neighboring base stations to satisfy the predefined criteria for at least a minimum length of time, fewer neighbor measurement reports may be issued, but the neighbor measurement reports that are issued may be based upon more reliable and/or more mature measurements, thereby avoiding excessive handovers and the resulting network inefficiencies.

The minimum amount of time, e.g., the time to trigger, that a measurement of a neighboring base station must satisfy the predefined criteria may be dependent upon the speed with which the mobile terminal is assumed to be moving. In this regard, the minimum amount of time that the measurements of a neighboring base station must satisfy the predefined criteria may be shorter in instances in which the mobile terminal is assumed to be moving at a relatively rapid rate and longer in instances in which the mobile terminal is assumed to be stationery or otherwise moving at a relatively slow speed. While such variations in the minimum amount of time that the measurements of the neighboring base stations must satisfy the predefined criteria is an effort to provide sufficient neighbor measurement reporting in instances in which the mobile terminal is moving at a relatively rapid rate, while avoiding unnecessary and inefficient neighbor measurement reporting in instances in which the mobile terminal is stationary or moving at a relatively slow speed, it would be desirable to further improve the manner in which a mobile terminal provides the neighbor measurement reporting in order to further increase the efficiency with which the neighbor measurement reports are made.

### BRIEF SUMMARY

Methods and apparatus are provided according to an example embodiment for creating neighbor measurement reports in accordance with a measure of mobility that takes into account whether a handover is mobility-triggered without consideration of non-mobility-triggered handovers. Accordingly, the measure of mobility may more accurately represent the mobility of the mobile terminals and is not impacted by non-mobility-triggered handovers that are not indicative of mobile terminal mobility. Accordingly, the neighbor measurement reports may be provided in accordance with an example embodiment of the present invention based upon a more accurate representation of the mobility of the mobile terminal, thereby potentially increasing the reliability of the neighbor measurement reports and the efficiency with which the neighbor measurement reports are issued and processed.

In one embodiment, a method is provided that includes receiving information indicating whether a handover is mobility triggered. The method may also determine, with a processor, a measure of mobility at least partially based upon the handovers that are mobility triggered without consideration of non-mobility triggered handovers. The method of this embodiment also causes neighbor measurement reports to be provided in accordance with the measure of mobility.

In another embodiment, an apparatus is provided that includes at least one processor and at least one memory including computer program code, with the at least one memory and the computer program code being configured to, with the at least one processor, cause the apparatus at least to receive information indicating whether a handover is mobility triggered. The at least one memory and the computer program code of this embodiment are also configured to, with the at least one processor, cause the apparatus to determine a measure of mobility at least partially based upon the handovers that are mobility triggered without consideration of non-mobility triggered handovers and to cause neighbor measurement reports to be provided in accordance with the measure of mobility.

In a further embodiment, a computer program product is provided that includes at least one non-transitory computer-readable storage medium having computer-readable program instructions stored therein with the computer-readable program instructions including program instructions configured to receive information indicating whether a handover is mobility triggered. The computer-readable program instructions may also include program instructions for determining a measure of mobility at least partially based upon the handovers that are mobility triggered without consideration of non-mobility triggered handovers. The computer-readable program instructions of this embodiment also include program instructions for causing neighbor measurement reports to be provided in accordance with the measure of mobility.

In yet another embodiment, an apparatus is provided that includes means for receiving information indicating whether a handover is mobility triggered. The apparatus may also include means for determining a measure of mobility at least partially based upon the handovers that are mobility triggered without consideration of non-mobility triggered handovers. The apparatus of this embodiment also includes means for causing neighbor measurement reports to be provided in accordance with the measure of mobility.

In one embodiment, a method is provided that includes receiving information indicating whether a handover is mobility triggered. The method of this embodiment also constructs, with a processor, a command to perform a handover that includes the information indicating whether the handover is mobility triggered. The method may also cause the command to perform a handover that includes the information indicating whether the handover is mobility triggered to be issued.

In another embodiment, an apparatus is provided that includes at least one processor and at least one memory including computer program code, with the at least one memory and the computer program code being configured to, with the at least one processor, cause the apparatus at least to receive information indicating whether a handover is mobility triggered. The at least one memory and the computer program code of this embodiment are also configured to, with the at least one processor, cause the apparatus to construct a command to perform a handover that includes the information indicating whether the handover is mobility triggered and to cause the command to perform a handover that includes the information indicating whether the handover is mobility triggered to be issued.

In a further embodiment, a computer program product is provided that includes at least one non-transitory computer-readable storage medium having computer-readable program instructions stored therein with the computer-readable program instructions including program instructions configured to receive information indicating whether a handover is mobility triggered. The computer-readable program instructions of this embodiment also include program instructions configured to construct a command to perform a handover that includes the information indicating whether the handover is mobility triggered. The computer-readable program instructions may also include program instructions configured to cause the command to perform a handover that includes the information indicating whether the handover is mobility triggered to be issued.

In yet another embodiment, an apparatus is provided that includes means for receiving information indicating whether a handover is mobility triggered. The apparatus of this embodiment also includes means for constructing a command to perform a handover that includes the information indicating whether the handover is mobility triggered. The apparatus may also include means for causing the command to perform a handover that includes the information indicating whether the handover is mobility triggered to be issued.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the invention in general terms, reference will now be made to the accompanying drawings, which are not necessarily drawn to scale, and wherein:

FIG. 1 illustrates a system including a mobile terminal, a source base station and a target base station configured to support the handover of the mobile terminal in accordance with one embodiment of the present invention;

FIG. 2 is a block diagram of a mobile terminal in accordance with one embodiment of the present invention;

FIG. 3 is a block diagram of a base station in accordance with one embodiment of the present invention;

FIG. 4 is a flow chart illustrating the operations performed from the perspective of a mobile terminal in accordance with one embodiment of the present invention; and

FIG. 5 is a flow chart illustrating the operations performed from the perspective of a target base station in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

A method, apparatus and computer program product are provided for supporting the handover of a mobile terminal from a source base station to a target base station in a reliable and efficient manner. In this regard, the method and apparatus may determine a measure of mobility of the mobile terminal that takes into account handovers that are mobility-triggered, but not non-mobility-triggered handovers. By providing neighbor measurement reports in accordance with the measure of mobility, the neighbor measurement reports may be at least partially based upon handovers that are mobility triggered without consideration of non-mobility-triggered handovers, thereby resulting in measurement reports that may be based upon more reliable and/or mature neighbor measurement data such that any handover of the mobile terminal from a source base station to a target base station may be accomplished in an efficient and reliable manner.

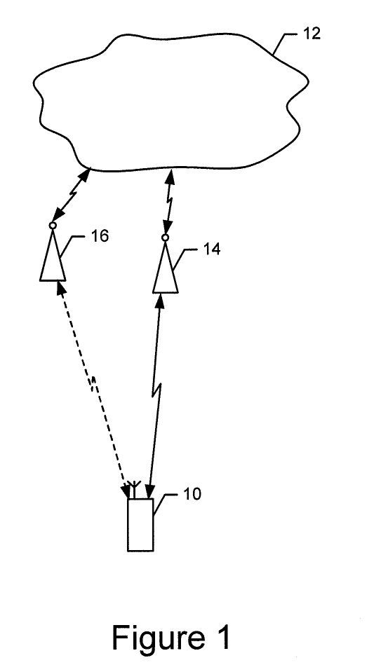

Although the method, apparatus and computer program product may be implemented in a variety of different systems, one example of such a system is shown in FIG. 1, which includes a first communication device (e.g., mobile terminal 10) that is capable of communication with a network 12 (e.g., a core network) via a base station 14 (e.g., a Node B, an evolved Node B (eNB), an access point or the like). While the network may be a EUTRAN configured in accordance with LTE or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 12 may include a collection of various different nodes, devices or functions that may be in communication with each other via corresponding wired and/or wireless interfaces. For example, the network may include a plurality of base stations, each of which may serve a coverage area divided into one or more cells. The base stations could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

A communication device, such as the mobile terminal 10 (also known as user equipment (UE)), may be in communication with other communication devices or other devices via the base station 14 and, in turn, the network 12. In some cases, the communication device may include an antenna for transmitting signals to and for receiving signals from a base station. The mobile terminal may be handed over from the base station 14, e.g., the source base station, currently supporting communications between the mobile terminal and the network to a neighboring base station, e.g., a target base station 16. Following the handover, the target base station may then support communications between the mobile terminal and the network. As described below, the handover may occur for various reasons including those relating to movement of the mobile terminal relative to the base stations, e.g., mobility triggered handovers, and those that are brought about for other reasons, such as load balancing, improved service, etc., e.g., non-mobility triggered handovers.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 12.

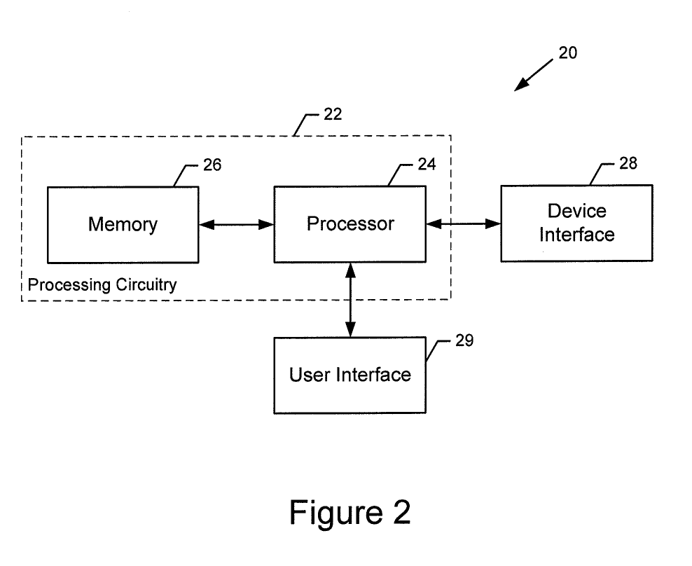

In one embodiment, for example, the mobile terminal 10 may be embodied as or otherwise include an apparatus 20 as generically represented by the block diagram of FIG. 2. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include one or more processors 24 and one or more memories 26 that may be in communication with or otherwise control a device interface 28 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 22. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

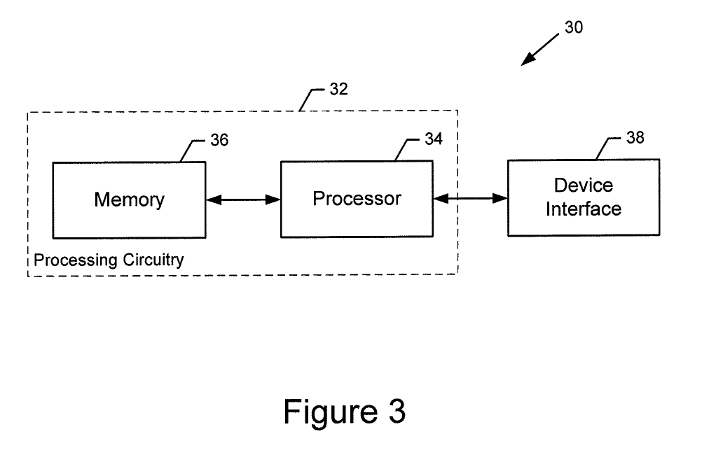

As noted above, a base station 14, 16 may be configured to communicate with the mobile terminal 10. In one embodiment, the base station may be embodied as or otherwise include an apparatus 30 as generically represented by the block diagram of FIG. 3. While the apparatus may be employed, for example, by a base station, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include one or more processors 34 and one or more memories 36 that may be in communication with or otherwise control a device interface 38. As such, the processing circuitry may be embodied as a circuit chip (e.g., an integrated circuit chip) configured (e.g., with hardware, software or a combination of hardware and software) to perform operations described herein. However, in some embodiments taken in the context of the base station, the processing circuitry may be embodied as a portion of a base station.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

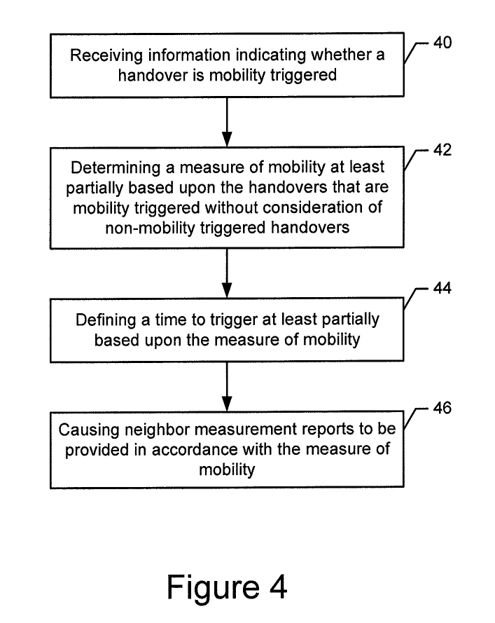

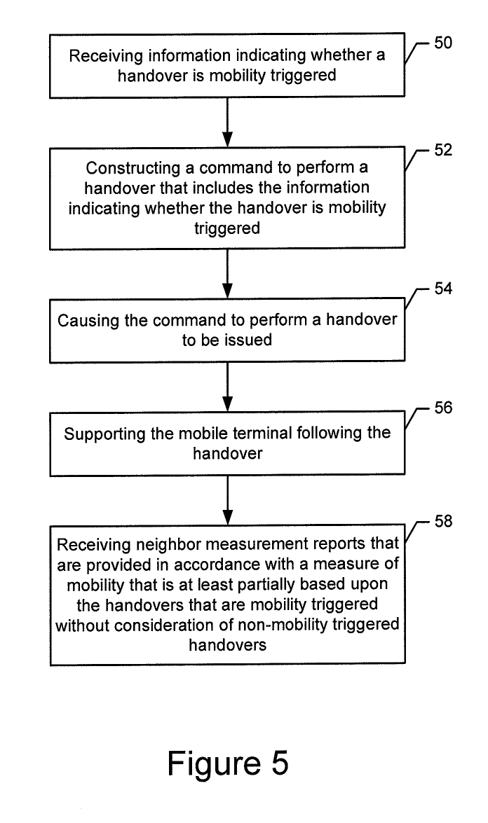

Referring now to FIGS. 4 and 5, flowcharts illustrating the operations performed by a method, apparatus and computer program product, such as apparatus 20 of FIG. 2 in regards to FIG. 4 and apparatus 30 of FIG. 3 in regards to FIG. 5, in accordance with one embodiment of the present invention are illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4 and 5, when executed, convert a computer or processing circuitry into a particular machine configured to perform an example embodiment of the present invention. Accordingly, the operations of each of FIGS. 4 and 5 define an algorithm for configuring a computer or processing circuitry, e.g., processor 24 in regards to FIG. 4 and processor 34 in regards to FIG. 5, to perform an example embodiment. In some cases, a general purpose computer may be provided with an instance of the processor which performs the algorithm of a respective one of FIGS. 4 and 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

With reference to FIG. 1 in which the mobile terminal 10 is currently supported by a source base station 14, such as in regards to network communications, the mobile terminal may receive a command advising the mobile terminal that the mobile terminal is being handed over from the source base station to a target base station 16 such that the target base station will support subsequent network communications for the mobile terminal. In accordance with an embodiment of the present invention, the handover command may include information indicating whether the handover is mobility triggered or non-mobility triggered. In this regard, the handover may be considered to be mobility-triggered in an instance in which the handover is a result of the movement of the mobile terminal relative to the source and target base stations with the movement resulting, for example, in the target base station being able to provide improved service, such as in terms of signal strength, signal quality or the like, relative to the source base station. In contrast, a non-mobility-triggered handover may be a handover that is initiated by the network 12, the base stations 14, 16 or the like for other purposes, such as to balance the load between the various base stations or to support the mobile terminal with a base station that can provide an improved quality of service, even though the mobile terminal has not moved, at least not appreciably, or the like.

As shown in operation 40 of FIG. 4, the mobile terminal 10 may therefore include means, such as the processing circuitry 22, the processor 24, the device interface 28 or the like, for receiving the information that is included within or otherwise associated with the handover command that indicates whether the handover is mobility-triggered. This information may be provided in various manners, such as in the mobilityControlInfo information element of an RRCConnectionReconfiguration protocol data unit (PDU). In one embodiment, for example, the handover command may include information that explicitly indicates whether the handover should be included in the mobility state determination, such as a subsequent determination of a measure of mobility of the mobile terminal. In this embodiment, the handover will be considered to be mobility triggered in an instance in which the information indicates that the handover should be included in the mobility state determination, e.g., the determination of the measure of mobility. Thus, the information that indicates that the handover should be included in the mobility state determination comprises information indicating that the handover is mobility triggered. Conversely, the handover will be considered to be non-mobility triggered in an instance in which the information indicates that the handover should not be included in the mobility state determination. Thus, the information that indicates that the handover should be included in the mobility state determination comprises information indicating that the handover is not mobility triggered.

In another embodiment, the handover command may include one or more bits that indicate whether the handover is mobility-triggered or is non-mobility-triggered. In this regard, the handover command may include a single bit that may have one predefined state indicating that the handover is mobility-triggered, and a different predefined state indicating that the handover is non-mobility triggered. Thus, by referencing the one or more bits included within the handover command of this embodiment, the mobile terminal such as the processing circuitry, the processor or the like, may determine whether the handover is mobility-triggered or non-mobility-triggered.

In yet another embodiment, the handover command may include handover cause information that indicates a cause of the handover. In this embodiment, instead of simply indicating whether the handover is mobility-triggered or non-mobility-triggered, the handover cause information may indicate the cause of the handover. For example, the handover cause information may include different codes or states that indicate that the handover is mobility-triggered, is triggered so as to balance the load between the base stations, is triggered so as to provide an improved quality of service for the mobile terminal regardless of the mobility of the mobile terminal, or the like. Based upon the handover cause information, the mobile terminal 10, such as the processing circuitry 22, the processor 24 or the like, may determine whether the handover is mobility-triggered or non-mobility-triggered.

As shown in operation 42 of FIG. 4, the mobile terminal 10 may also include means, such as the processing circuitry 22, the processor 24 or the like, for determining a measure of mobility. The measure of mobility may be at least partially based upon the handovers that are mobility-triggered and without consideration of non-mobility-triggered handovers. The measure of mobility may be determined in various manners. In one embodiment, however, the mobile terminal, such as the processing circuitry, the processor or the like, may determine the measure of mobility based upon the number of mobility-triggered handovers that occur within a predefined period of time. By basing the measure of mobility upon the mobility-triggered handovers, the mobile terminal, such as the processing circuitry, the processor or the like, may exclude non-mobility triggered handovers from the determination of the measure of mobility. As such, the measure of mobility as determined in accordance with an embodiment of the present invention may be more accurately reflective of the mobility of the mobile terminal since the measure of mobility is not influenced by non-mobility-triggered handovers that are not indicative of the mobility of the mobile terminal. Thus, by excluding non-mobility-triggered handovers from the determination of the measure of mobility, the measure of mobility will not be undesirably inflated by the non-mobility triggered handovers.

As shown in operation 44 of FIG. 4, the mobile terminal 10 may include means, such as the processing circuitry 22, the processor 24 or the like, for defining a time to trigger that is at least partially based upon the measure of mobility. In this regard, a time to trigger may be a minimum length of time that one or more parameters associated with the performance of a neighboring base station, e.g., signal strength or signal quality, must satisfy a predefined criteria in order to cause the mobile terminal to issue a neighbor measurement report. By adjusting the time to trigger based upon the mobility of the mobile terminal, the time to trigger may, for example, have a predetermined value in an instance in which a mobile terminal is stationary or is moving at less than a first predefined speed, such as defined by a mobile terminal having less than a first predetermined number of handovers in a predefined period of time. However, if the mobile terminal is determined, such as by the processing circuitry, the processor or the like, to be moving at a speed that is greater than the first predetermined speed, such as by experiencing more than the first predetermined number of handovers in the predefined period of time, the time to trigger may be reduced such that more frequent neighbor measurement reports may be issued. The time to trigger may be adjusted even further, such as by being further reduced, in instances in which the mobile terminal is determined to be moving at even greater rates of speed.

In the past, the time to trigger was also influenced by non-mobility-triggered handovers since non-mobility-triggered handovers were included in the determination of the speed of the mobile terminal. As such, non-mobility-triggered handovers could cause the time to trigger to be reduced in an unnecessary, undesirable manner since the speed of the mobile terminal 10 was partially based upon non-mobility-triggered handovers even though non-mobility triggered handovers are not indicative of the speed of the mobile terminal. By unnecessarily reducing the time to trigger based upon non-mobility-triggered handovers, a mobile terminal may have issued a larger number of neighbor measurement reports that were, on average, based upon potentially less reliable and/or less mature measurement results. Not only does the increase in neighbor measurement reports increase the network traffic, but the neighbor measurement reports may have caused the mobile terminal to be handed over to a target base station 16 in instances in which the handover was unnecessary and/or otherwise resulted in non-optimal network utilization and/or connection drops.

In accordance with example embodiments of the present invention, however, the speed of the mobile terminal 10 is represented by the measure of mobility which, as described above, is based upon the mobility-triggered handovers, but not the non-mobility-triggered handovers. As such, by defining the time to trigger based, as least in part, upon the measure of mobility that is influenced by mobility-triggered handovers, but not non-mobility-triggered handovers, the time to trigger will similarly be influenced by mobility-triggered handovers, but not non-mobility-triggered handovers. Thus, the time to trigger will be more accurately based on the speed of the mobile terminal and will not be undesirably biased by non-mobility-triggered handovers that are not indicative of the speed of the mobile terminal.

As shown in operation 46 of FIG. 4, the mobile terminal 10 may also include means, such as the processing circuitry 22, the processor 24, the device interface 28 or the like, for causing neighbor measurement reports to be provided in accordance with the measure of mobility. Indeed, in an embodiment in which a time to trigger is defined at least partially based upon the measure of mobility, the mobile terminal, such as the processing circuitry, the processor, the device interface or the like, may cause neighbor measurement reports to be provided in accordance with the time to trigger. The neighbor measurement reports may provide information regarding a variety of parameters reflective of signals exchanged between the mobile terminal and one or more neighboring base stations, such as parameters indicative of the signal strength, signal quality or the like. By causing the neighbor measurement reports to be provided in accordance with the measure of mobility, the neighbor measurement reports are provided based, as least in part, upon the mobility of the mobile terminal as defined by the number of mobility-triggered handovers in a predefined period of time, without consideration of non-mobility-triggered handovers that are not indicative of the speed or other movement of the mobile terminal. Indeed, in an instance in which the time to trigger is at least partially based upon the measure of mobility, the neighbor measurement reports may be provided once one or more parameters reflective of the signals exchanged between the mobile terminal and the neighboring base station has satisfied respective predefined thresholds for at least the time to trigger. In embodiments of the present invention, the time to trigger will also be more accurately defined based upon the speed or mobility of the mobile terminal which, in turn, is based upon the number of mobility-triggered handovers without consideration of the non-mobility-triggered handover.

By therefore only causing neighbor measurement reports to be provided in instances in which the time to trigger that has been satisfied is fully based upon the mobility of the mobile terminal 10 as defined by the mobility-triggered handovers and not by non-mobility-triggered handovers, neighbor measurement reports will be issued that are based upon more reliable and/or more mature measurement results. Based upon the neighbor measurement reports, a network 10 and/or the source base station 14 may determine that a handover to a target base station 16 is appropriate, and the mobile terminal may receive a handover command advising the mobile terminal of the handover and, in accordance with an example embodiment of the present invention, providing information regarding whether the handover is mobility triggered or not. By providing neighbor measurement reports that are based upon more reliable and/or more mature measurement results, however, the number of unnecessary handovers may be reduced, thereby improving network utilization and reducing connection drops.

As shown in FIG. 5, the operations of a base station, such as a target base station 16, are shown. In an instance in which a mobile terminal 10 is to be handed over from a source base station 14 to a target base station, the source base station may transmit a message to the target base station advising the target base station that the mobile terminal is to be handed over to the target base station. In accordance with an example embodiment of the present invention, the message transmitted from the source base station to the target base station may indicate whether the handover is mobility-triggered or non-mobility-triggered.

As shown in operation 50 of FIG. 5, the target base station 16 may include means, such as the processing circuitry 32, the processor 34, the device interface 36 or the like, for receiving information indicating whether the handover of the mobile terminal 10 is mobility-triggered. In one embodiment, the message provided by the source base station 14 to the target base station is provided by the source base station to a mobility management entity (MME) that, in turn, provides a message including the information indicating whether the handover is mobility-triggered to the target base station. As described above, the information indicating whether the handover is mobility triggered may be information that indicates whether the handover is to be included in the mobility state determination, e.g., the determination of the measure of mobility. In this instance, the handover may be considered mobility triggered in an instance in which the information indicates that the handover is to be included in the mobility state determination and may be considered not to be mobility triggered in an instance in which the information indicates that the handover is not to be included in the mobility state determination.

The target base station 16 may include means, such as the processing circuitry 32, the processor 34 or the like, for constructing a handover command based upon the message from the source base station 14. See operation 52. In accordance with an example embodiment, the target base station, such as the processing circuitry, the processor or the like, may construct the handover command so as to include information indicating whether the handover is mobility-triggered. As described above, the information indicating whether the handover is mobility-triggered may be provided in various manners, including an explicit command indicating whether or not to include the handover in a mobility state determination, one or more bits indicating whether the handover is mobility-triggered or the inclusion of handover cause information indicating the cause of the handover.

The target base station 16, such as the processing circuitry 32, the processor 34, the device interface 36 or the like, may also include means for causing the handover command, that is, a command to perform a handover, to be issued. See operation 54. In this regard, the handover command that is issued includes the information indicating whether the handover is mobility-triggered. In one embodiment, the target base station causes the handover command to be transmitted to the source base station 14, either directly or via the MME. The source base station of this embodiment may then provide the handover command or some representation thereof, including the information indicating whether the handover is mobility-triggered to the mobile terminal 10. In instances in which the criteria for a handover from the source base station to the target base station is satisfied, the mobile terminal may be handed over to the target base station which, in turn, begins supporting the mobile terminal in regards to its network communications and the like, as shown in operation 56 of FIG. 5.

Following the handover, the target base station 16 may include means, such as the processing circuitry 32, the processor 34, the device interface 36 or the like, for receiving measurement reports. See operation 58. The measurement reports may be provided by the mobile terminal 10, as described above and in accordance with a measure of mobility that is at least partially based upon the handovers that are mobility-triggered without consideration of the non-mobility-triggered handovers. In one embodiment in which a time to trigger is defined based at least in part upon the measure of mobility, the neighbor measurement reports that are received by the base station will have been provided in accordance with the time to trigger. By having based the time to trigger upon the mobility-triggered handovers without consideration of the non-mobility-triggered handovers, the time to trigger will not be undesirably affected by the non-mobility-triggered handovers and may be a more accurate representation of the speed with which the mobile terminal is moving. As such, the neighbor measurement reports that are provided may be provided somewhat less frequently (at least in an instance in which there have been some non-mobility-triggered handovers), but may be based upon potentially more reliable and/or more mature measurement results, thereby resulting in fewer unnecessary handovers and improved network utilization and/or reduced numbers of connection drops.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving information indicating whether a handover is mobility triggered;
determining, with a processor, a measure of mobility at least partially based upon the handovers that are mobility triggered without consideration of non-mobility triggered handovers; and
causing neighbor measurement reports to be provided in accordance with the measure of mobility.

2. A method according to claim 1 wherein receiving information comprises receiving a command to perform a handover that includes the information indicating whether the handover is mobility triggered.

3. A method according to claim 2 wherein receiving the command to perform a handover comprises receiving the command to perform a handover that includes at least one bit indicating whether the handover is mobility triggered.

4. A method according to claim 2 wherein receiving the command to perform a handover comprises receiving the command to perform a handover that includes handover cause information indicating a cause of the handover.

5. A method according to claim 2 wherein receiving the command to perform the handover comprises receiving the command to perform a handover that includes an indication whether the handover is to be included in a determination of the measure of mobility.

6. A method according to claim 1 further comprising defining a time to trigger at least partially based upon the measure of mobility, wherein causing neighbor measurement reports to be provided comprises causing neighbor measurement reports to be provided in accordance with the time to trigger.

7. A method according to claim 1 wherein determining the measure of mobility comprises excluding non-mobility triggered handovers from the determination of the measure of mobility.

8. An apparatus comprising:
at least one processor; and
at least one memory including computer program code,
the at least one memory and the computer program code configured to, with the at least one processor, cause the apparatus at least to:
receive information indicating whether a handover is mobility triggered;
determine a measure of mobility at least partially based upon the handovers that are mobility triggered without consideration of non-mobility triggered handovers; and
cause neighbor measurement reports to be provided in accordance with the measure of mobility.

9. An apparatus according to claim 8 wherein the at least one memory and the computer program code are configured to, with the at least one processor, cause the apparatus to receive information by receiving a command to perform a handover that includes the information indicating whether the handover is mobility triggered.

10. An apparatus according to claim 9 wherein the at least one memory and the computer program code are configured to, with the at least one processor, cause the apparatus to receive the command to perform a handover by receiving the command to perform a handover that includes at least one bit indicating whether the handover is mobility triggered.

11. An apparatus according to claim 9 wherein the at least one memory and the computer program code are configured to, with the at least one processor, cause the apparatus to receive the command to perform a handover by receiving the command to perform a handover that includes handover cause information indicating a cause of the handover.

12. An apparatus according to claim 9 wherein the at least one memory and the computer program code are configured to, with the at least one processor, cause the apparatus to receive the command to perform the handover by receiving the command to perform a handover that includes an indication whether the handover is to be included in a determination of the measure of mobility.

13. An apparatus according to claim 8 wherein the at least one memory and the computer program code are further configured to, with the at least one processor, cause the apparatus to determine the measure of mobility by excluding non-mobility triggered handovers from the determination of the measure of mobility.

14. An apparatus according to claim 8 wherein the apparatus comprises a mobile terminal.

15. An apparatus according to claim 14 further comprising a device interface configured to communicate with a base station in order to receive the information indicating whether a handover is mobility triggered and to provide neighbor measurement reports in accordance with the measure of mobility.

16. An apparatus according to claim 8 wherein the processor is configured for use in a Long Term Evolution (LTE) system.

17. A method comprising:
receiving information indicating whether a handover is mobility triggered;
constructing, with a processor, a command to perform a handover that includes the information indicating whether the handover is mobility triggered; and
causing the command to perform a handover that includes the information indicating whether the handover is mobility triggered to be issued.

18. A method according to claim 17 wherein constructing the command to perform a handover comprises constructing the command to perform a handover that includes at least one bit indicating whether the handover is mobility triggered.

19. A method according to claim 17 wherein constructing the command to perform a handover comprises constructing the command to perform a handover that includes handover cause information indicating a cause of the handover.

20. A method according to claim 17 wherein constructing the command to perform a handover comprises constructing the command to perform a handover that includes an indication whether the handover is to be included in a determination of the measure of mobility.
